(19) United States
(12) Patent Application Publication
(10) Pub. No.: US 2018/0172960 A1
(43) Pub. Date: Jun. 21, 2018

(54) Wide Angle Lens And Imaging Device Including The Same

(71) Applicant: KOLEN CO., LTD., Seongnam-si (KR)

(72) Inventors: Gi Sung Park, Gyeonggi-do (KR); Jong Jin Lee, Seoul (KR); Hyung Soo Kim, Suwon-si (KR)

(21) Appl. No.: 15/848,512

(22) Filed: Dec. 20, 2017

(30) Foreign Application Priority Data
Dec. 21, 2016 (KR) 10-2016-0175835

(51) Int. Cl. G02B 13/06; G02B 9/62; G02B 27/00

(52) U.S. Cl. CPC G02B 13/06; G02B 27/0025; G02B 9/62

(57) ABSTRACT

Disclosed are a wide angle lens and an imaging device including the same. The wide angle lens includes a first lens having a negative refractive power, a second lens having a negative refractive power, a third lens having a positive refractive power, a fourth lens having a positive refractive power, a fifth lens having a positive refractive power, and a sixth lens having a negative refractive power, wherein the first lens, the second lens, the third lens, the fourth lens, the fifth lens, and the sixth lens are sequentially disposed from an object side to an image plane side. The wide angle lens satisfies a conditional expression of (FOV/2)*(π/180)/IH>EFL. Here, FOV denotes an angle of view of the wide angle lens, IH denotes an image height of the wide angle lens, and EFL denotes an effective focal length of the wide angle lens.

### FIELD OF THE INVENTION

One or more embodiments relate to a wide angle lens and an imaging device including the same.

### BACKGROUND OF THE INVENTION

Imaging devices using solid-state imaging elements such as charge-coupled device (CCD) type image sensors or complementary metal-oxide semiconductor (CMOS) type image sensors are widely used. In an imaging device using a solid-state imaging element such as a digital camera, an interchangeable lens system, a video camera, and the like, users demand high resolution and high quality. The imaging device using the solid-state imaging element is suitable for miniaturization, and thus the imaging device has recently been applied to a small information terminal including a cellular phone and the like.

It is necessary for a wide angle lens to be miniaturized as well as have superior optical performance. It is necessary for a high performance wide angle to have a small size in addition to an inexpensive configuration to be applied to applications such as a camera for a vehicle and a surveillance camera.

### SUMMARY OF THE INVENTION

One or more embodiments include a wide angle lens and an imaging device including the same.

Additional aspects will be set forth in part in the description which follows and, in part, will be apparent from the description, or may be learned by practice of the presented embodiments.

According to one or more embodiments, a wide angle lens includes a first lens having a negative refractive power and an incident surface that is convex toward an object side; a second lens having a negative refractive power; a third lens having a positive refractive power and an exit surface that is concave toward an image plane side; a fourth lens having a positive refractive power; a fifth lens having a positive refractive power; and a sixth lens having a negative refractive power and an exit surface that is convex toward the image plane side, wherein the first to sixth lenses are sequentially disposed from the object side to the image plane side, and the wide angle lens satisfies Conditional Expression 1 as follows:

(FOV/2)*(π/180)/IH>EFL [Conditional Expression 1]

Here, FOV (having a unit of °) denotes an angle of view of the wide angle lens, IH denotes an image height of the wide angle lens, and EFL denotes an effective focal length of the wide angle lens.

The wide angle lens may satisfy Conditional Expression 2 as follows:

FOV>180° [Conditional Expression 2]

Here, FOV (having the unit is °) denotes the angle of view of the wide angle lens.

The wide angle lens may satisfy Conditional Expression 3 as follows:

EFL/f3>0.25 [Conditional Expression 3]

Here, EFL denotes the effective focal length of the wide angle lens, and f3 denotes a focal length of the third lens.

The wide angle lens may satisfy Conditional Expression 4 as follows:

|R7|/|R8|>1.5 [Conditional Expression 4]

Here, |R7| denotes an absolute value of a radius of curvature of an incident surface of the fourth lens L4, and |R8| denotes an absolute value of a radius of curvature of an exit surface of the fourth lens L4.

The wide angle lens may satisfy Conditional Expression 5 as follows:

Vd3+Vd6<50 [Conditional Expression 5]

Here, Vd3 denotes an Abbe number of a d-line of the third lens, and Vd6 denotes an Abbe number of a d-line of the sixth lens.

The first lens and the fourth lens may be each made of a glass material.

The second lens and the fifth lens may be each made of a plastic material.

The third lens and the sixth lens may be made of the same material.

The third lens and the sixth lens may be each made of a plastic material.

The wide angle lens may further include an aperture provided at the third lens toward the object side.

At least one lens among the second lens, the third lens, the fifth lens, and the sixth lens may be an aspherical lens.

The first lens may be a meniscus lens that is concave toward the image plane side.

The wide angle lens may further include an optical block provided at the sixth lens toward the object side.

According to one or more embodiments, a wide angle lens includes a first lens having a negative refractive power; a second lens having a negative refractive power; a third lens having a positive refractive power; a fourth lens having a positive refractive power and an exit surface that is convex toward an image plane side; a fifth lens having a positive refractive power; and a sixth lens having a negative refractive power, wherein the first to sixth lenses are sequentially disposed from an object side to the image plane side, and the wide angle lens satisfies Conditional Expressions 1 and 2 as follows:

(FOV/2)*(π/180)/IH>EFL, and [Conditional Expression 1]

|R7|/|R8|>1.5 [Conditional Expression 2]

Here, FOV (having a unit of °) denotes an angle of view of the wide angle lens, IH denotes an image height of the wide angle lens, EFL denotes an effective focal length of the wide angle lens, |R7| denotes an absolute value of a radius of curvature of an incident surface of the fourth lens, and |R8| denotes an absolute value of a radius of curvature of the exit surface of the fourth lens.

The wide angle lens may satisfy Conditional Expression 3 as follows:

FOV>180° [Conditional Expression 3]

Here, FOV (having the unit of °) denotes the angle of view of the wide angle lens.

The wide angle lens may satisfy Conditional Expression 4 as follows:

EFL/f3>0.25 [Conditional Expression 4]

Here, EFL denotes the effective focal length of the wide angle lens, and f3 denotes a focal length of the third lens.

The wide angle lens may satisfy Conditional Expression 5 as follows:

Vd3+Vd6<50 [Conditional Expression 5]

Here, Vd3 denotes an Abbe number of a d-line of the third lens, and Vd6 denotes an Abbe number of a d-line of the sixth lens.

The first lens and the fourth lens may be each made of a glass material.

The second lens, the third lens, the fifth lens, and the sixth lens may be each made of a plastic material.

According to one or more embodiments, an imaging device includes the wide angle lens according to the above-described various embodiments; and a solid-state imaging element configured to take an image formed by the wide angle lens.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view schematically illustrating an arrangement of main components of a wide angle lens according to a first embodiment;

FIG. 2 is a numerical diagram illustrating a spherical aberration, astigmatism, and a distortion of the wide angle lens according to the first embodiment;

FIG. 3 is a cross-sectional view schematically illustrating an arrangement of main components of a wide angle lens according to a second embodiment;

FIG. 4 is a numerical diagram illustrating a spherical aberration, astigmatism, and a distortion of the wide angle lens according to the second embodiment;

FIG. 5 is a cross-sectional view schematically illustrating an arrangement of main components of a wide angle lens according to a third embodiment;

FIG. 6 is a numerical diagram illustrating a spherical aberration, astigmatism, and a distortion of the wide angle lens according to the third embodiment;

FIG. 7 is a cross-sectional view schematically illustrating an arrangement of main components of a wide angle lens according to a fourth embodiment;

FIG. 8 is a numerical diagram illustrating a spherical aberration, astigmatism, and a distortion of the wide angle lens according to the fourth embodiment;

FIG. 9 is a cross-sectional view schematically illustrating an arrangement of main components of a wide angle lens according to a fifth embodiment;

FIG. 10 is a numerical diagram illustrating a spherical aberration, astigmatism, and a distortion of the wide angle lens according to the fifth embodiment; and

FIG. 11 is a perspective view schematically illustrating an imaging device including a wide angle lens according to the disclosure.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Hereinafter, a wide angle lens and an imaging device according to embodiments of the disclosure will be described in detail with reference to the accompanying drawings. Like reference numerals designate the same (or similar) elements throughout the description.

In the following description, the term “image plane (IMG)” refers to a plane on which an image is formed by passing through a wide angle lens, and the term “IMG side” may refer to a direction in which an imaging element such as an image sensor and the like is disposed. On the basis of a wide angle lens, an “object (OBJ) side” and the “IMG side” may refer to opposite directions. Also, a surface among two surfaces of a lens toward the OBJ side may be referred to as an incident surface, and a surface among the two surfaces thereof toward the IMG side may be referred to as an exit surface.

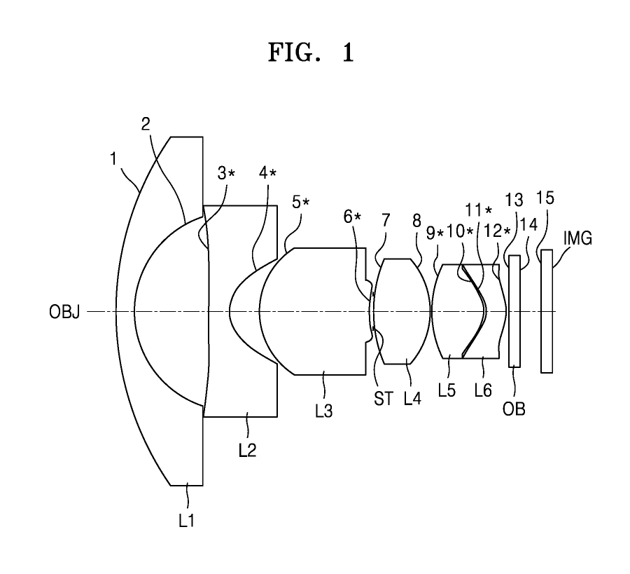

FIG. 1 is a cross-sectional view schematically illustrating an arrangement of main components of a wide angle lens according to a first embodiment.

The wide angle lens includes first to sixth lenses L1 to L6 which are sequentially disposed from an OBJ side to an IMG side. For example, the first lens L1 may have a negative refractive power, the second lens L2 may have a negative refractive power, the third lens L3 may have a positive refractive power, the fourth lens L4 may have a positive refractive power, the fifth lens L5 may have a positive refractive power, and the lens L6 may have a negative refractive power.

For example, the first lens L1 may include an exit surface 2 that is concave toward the IMG side. For example, the first lens L1 may include an incident surface 1 that is convex toward the OBJ side. For example, the first lens L1 may have a meniscus shape that is concave toward the IMG side.

For example, the second lens L2 may include an exit surface 4* that is concave toward the IMG side. For example, the second lens L2 may include an incident surface 3* that is concave toward the OBJ side. For example, the second lens L2 may have a biconcave shape. For example, an absolute value of a radius of curvature of the incident surface 3* of the second lens L2 may be greater than that of a radius of curvature of the exit surface 4* thereof.

For example, the third lens L3 may have an exit surface 6* that is concave toward the IMG side. For example, the third lens L3 may have an incident surface 5* that is convex toward the OBJ side. For example, the third lens L3 may have a meniscus shape that is concave toward the IMG side.

For example, the fourth lens L4 may include an exit surface 8 that is convex toward the IMG side. For example, the fourth lens L4 may include an incident surface 7 that is convex toward the OBJ side. For example, the fourth lens L4 may have a biconvex lens shape. An absolute value of a radius of curvature of the incident surface 7 of the fourth lens L4 may be greater than that of a radius of curvature of the exit surface 8 thereof. This arrangement of the radius of curvature allows the refractive power of the fourth lens L4 to be mainly disposed on the exit surface 8, thereby reducing performance degradation due to process and assembly errors of a lens.

For example, the fifth lens L5 may include an exit surface 10* that is convex toward the IMG side. For example, the fifth lens L5 may include an incident surface 9* that is convex toward the OBJ side. For example, the fifth lens L5 may have a biconvex lens shape.

For example, the sixth lens L6 may include an exit surface 12* that is convex toward the IMG side. For example, the sixth lens L6 may include an incident surface 11* that is concave toward the OBJ side.

In the wide angle lens according to various embodiments, the third lens L3, the fourth lens L4, and the fifth lens L5 may be disposed to have a positive refractive power, and thus an image may be effectively focused on the IMG, and aberration correction may be obtained via the three lenses L3, L4, and L5 so that an aberration may be effectively corrected.

The fifth lens L5 and the sixth lens L6 may be aspherical lenses, and thus the wide angle lens according to various embodiments may have a wide vertical angle of view. The wide angle lens having a wide vertical angle of view may be easily applied to a vehicle application.

At least one optical block (OB) may be provided between the sixth lens L6 and the IMG. For example, the OB may include at least one cut filter among a low pass filter, an infrared (IR) cut filter, and a cover glass. For example, when the IR cut filter is provided as the OB, visible light may be transmitted therethrough, and IR light may be reflected to the outside such that the IR light may not be transmitted to the IMG. However, the disclosure is not limited thereto, and the wide angle lens may be configured without the OB.

An aperture (ST) may be provided between the third lens L3 and the fourth lens L4.

At least one of the first to sixth lenses L1 to L6 may be an aspherical lens. For example, the second lens L2, the third lens L3, the fifth lens L5, and the sixth lens L6 may be aspherical lenses. For example, the second lens L2, the third lens L3, the fifth lens L5, and the sixth lens L6 may be made of plastic materials. A lens formed of a plastic material may have a lighter weight than that of a lens formed of a glass material, and mass production thereof may be facilitated. Further, a plastic lens has a lower manufacturing cost than that of a glass lens and a lighter constraint condition on lens molding than the glass lens such that the plastic lens may be easily miniaturized. For example, the wide angle lens according to the embodiment of the disclosure may achieve miniaturization and weight reduction by all of the second lens L2, the third lens L3, the fifth lens L5, and the sixth lens L6 being manufactured with plastic materials.

At least one of the first to sixth lenses L1 to L6 may be a spherical lens. For example, the first lens L1 and the fourth lens L4 may be spherical lenses. For example, the first lens L1 and the fourth lens L4 may be made of glass materials. A lens made of a glass material may have lower dispersion than that of a lens made of a plastic material, and may have little variation in focus and refractive index relative to a temperature change. The wide angle lens according to the present embodiment allows the fourth lens L4 to have a strong positive refractive power, thereby focusing an image on an IMG and correcting an aberration, and thus the wide angle lens may be made of a glass material to prevent variation in focus and refractive power relative to a temperature change.

The wide angle lens according to the present embodiment may simultaneously realize cost reduction, ease of implementation of an aspherical surface, and durability to a temperature change by employing a lens made of a glass material and a lens made of a plastic material.

The wide angle lens according to present embodiment may have a wide angle of view, for example, a 180 degree or more angle of view. Further, the wide angle lens according to the present embodiment may have a small face (F) number, for example, a F-number of 2.5 or less, which is advantageous for bright imaging. The wide angle lens according to the present embodiment may have a wide angle of view in a vertical direction while having superior wide angle performance.

The wide angle lens according to the embodiment may satisfy at least one of the following Conditional Expressions 1 to 5.

(FOV/2)*(π/180)/IH>EFL [Conditional Expression 1]

Here, FOV (having a unit of °) denotes an angle of view of the wide angle lens, IH denotes an image height of the wide angle lens, and EFL denotes an effective focal length of the wide angle lens.

In Conditional Expression 1, the term FOV/2 refers to a half angle of view of the wide angle lens, and the term π/180 is a term that converts an angle(°) into a radian (rad). For example, in order to satisfy Conditional Expression 1, the fifth lens L5 and the sixth lens L6 may be aspherical lenses.

Conditional Expression 1 may refer to a condition for a mapping function. For example, in the case of a general optical system, when an image height is y and an angle of view is θ, the following mapping functions may be defined as follows. Linear scaled equidistance mapping may be defined as y=f*θ, orthographic mapping may be defined as y=f*sin (θ), equisolid angle mapping may be defined as y=2*f*sin(θ/2), and stereographic mapping may be defined as y=2*f*tan(θ/2).

When Conditional Expression 1 is transformed into a mapping function form, Conditional Expression 1 is transformed into (θ/2)/EFL>y, and a wide angle lens satisfying Conditional Expression 1 may obtain a vertical angle of view θ that is larger than those of other mappings having the same horizontal angle of view condition.

The wide angle lens according to the above-described embodiment may satisfy the following Conditional Expression 2.

FOV>180° [Conditional Expression 2]

Here, FOV (having a unit of °) denotes the angle of view of the wide angle lens. The wide angle lens satisfying Conditional Expression 2 may have a 180 degree or more wide angle.

The wide angle lens according to the above-described embodiment may satisfy the following Conditional Expression 3.

EFL/f3>0.25 [Conditional Expression 3]

Here, EFL denotes the effective focal length of the wide angle lens, and f3 denotes a focal length of the third lens. The wide angle lens satisfying Conditional Expression 3 allows the third lens L3 to have a sufficient positive refractive power to correct an aberration and focus an image. For example, when EFL/f3 is smaller than a lower limit value according to Conditional Expression 3, the positive refractive power of the third lens L3 is weak, and thus it may not be easy to correct an aberration and focus an image.

The wide angle lens according to the above-described embodiment may satisfy the following Conditional Expression 4.

|R7|/|R8|>1.5 [Conditional Expression 4]

Here, |R7| denotes an absolute value of a radius of curvature of an incident surface of the fourth lens L4, and |R8| denotes an absolute value of a radius of curvature of an exit surface of the fourth lens L4. The fourth lens L4 satisfying Conditional Expression 4 may dispose the refractive power thereof at the exit surface 8, thereby preventing performance deterioration due to process and assembly errors of a lens. For example, when |R7|/|R8| is smaller than a lower limit value according to Conditional Expression 4, process and assembly errors of a lens may occur.

The wide angle lens according to the above-described embodiment may satisfy the following Conditional Expression 5.

Vd3+Vd6<50 [Conditional Expression 5]

Here, Vd3 denotes an Abbe number of a d-line of the third lens, and Vd6 denotes an Abbe number of a d-line of the sixth lens. Conditional Expression 5 is a conditional expression related to materials of the third lens L3 and the sixth lens L6. The third lens L3 and the sixth lens L6, which satisfy Conditional Expression 5, may be able to suitably correct an axial chromatic aberration and a chromatic aberration of magnification via an arrangement of dispersion characteristics. The third lens L3 and the sixth lens L6 may be formed of the same material to satisfy Conditional Expression 5. For example, third lens L3 and sixth lens L6 may be made of plastic materials.

Meanwhile, an aspherical surface used in the wide angle lens according to the embodiment of the disclosure is defined as follows.

$$〈 Aspherical Surface Equation 〉$$

$$Z = \frac{{Y}^{2}}{R ( 1 + \sqrt{1 - ( 1 + K ) {Y}^{2} / {R}^{2}}} + {AY}^{4} + {BY}^{6} + {CY}^{8} + {DY}^{10} + {EY}^{12} + {FY}^{14} + {GY}^{16} + {HY}^{18} + {JY}^{20}$$

Here, Z denotes a distance from a vertex of a lens in an optical axis direction, Y denotes a distance in a direction perpendicular to an optical axis, K denotes a conic constant, A, B, C, D, E, F, G, H, and J denote aspherical surface coefficients, and R denotes a radius of curvature.

In the disclosure, the wide angle lens may be implemented by numerical examples according to various designs as follows. In each numerical example, F-numbers (e.g., 1, 2, 3, . . . , and N, wherein N is a natural number) of lenses are sequentially disposed from the OBJ side to the IMG side, and are shown in the drawings. Further, OBJ denotes an object, IMG denotes an image plane, R denotes a radius of curvature, D denotes a thickness of a lens or an air gap between lenses, Nd denotes a refractive index, and Vd denotes an Abbe number. ST denotes an aperture, “*” denotes an aspherical surface, and OB denotes an optical block.

### FIRST NUMERICAL EXAMPLE

FIG. 1 shows a wide angle lens according to a first numerical example, and design data of the first numerical example is shown below.

TABLE 1

| | F-number | R | D | Nd | Vd |
|---|---|---|---|---|---|
| L1 | 1 | 10.98979 | 0.65 | 1.7725 | 49.6 |
| | 2 | 3.593658 | 2.718692 | | |
| L2 | *3 | −113.507 | 0.739609 | 1.5365 | 55.9 |
| | *4 | 1.187124 | 1.078052 | | |
| L3 | *5 | 2.790664 | 4 | 1.6322 | 23.3 |
| | *6 | 4.52608 | 0.135776 | | |
| | 7(St) | ∞ | 0.01 | | |
| L4 | 8 | 4.780926 | 2.059601 | 1.6204 | 60.3 |
| | 9 | −2.84583 | 0.05 | | |
| L5 | *10 | 3.793082 | 1.880984 | 1.5365 | 55.9 |
| | *11 | −1.09697 | 0.091029 | | |
| L6 | *12 | −0.8384 | 0.720788 | 1.6322 | 23.3 |
| | *13 | −1.5906 | 0.1 | | |
| OB | 14 | ∞ | 0.4 | 1.523 | 39.1 |
| | 15 | ∞ | 0.775 | | |
| | 16 | ∞ | 0.4 | 1.517 | 64.2 |
| | IMG | ∞ | 0.125 | | |

TABLE 2

| S | K | A | B | C | D | E | F | G |
|---|---|---|---|---|---|---|---|---|
| *3 | 0.00E+00 | 2.38E−03 | −7.66E−04 | 7.70E−05 | −4.03E−06 | 9.43E−08 | 0.00E+00 | 0.00E+00 |
| *4 | −8.00E−01 | −1.34E−02 | 1.58E−02 | −2.76E−03 | −7.64E−04 | 1.43E−04 | 0.00E+00 | 0.00E+00 |
| *5 | 0.00E+00 | 1.39E−03 | 5.65E−03 | −1.45E−03 | 8.03E−05 | 0.00E+00 | 0.00E+00 | 0.00E+00 |
| *6 | 0.00E+00 | 4.47E−02 | −1.03E−01 | 2.86E−01 | −2.69E−01 | 0.00E+00 | 0.00E+00 | 0.00E+00 |
| *10 | 1.06E+00 | −3.61E−03 | 1.50E−03 | 6.19E−04 | −1.30E−03 | 9.75E−05 | 1.67E−04 | −3.02E−05 |
| *11 | −1.70E+00 | 2.08E−02 | 7.05E−03 | −9.57E−03 | 2.13E−03 | 2.60E−04 | −8.10E−05 | 2.71E−06 |
| *12 | −1.79E+00 | 6.05E−02 | −1.20E−02 | −2.27E−03 | 1.08E−03 | −4.95E−05 | 1.50E−04 | −4.83E−05 |
| *13 | −3.80E+00 | 4.87E−02 | −4.58E−03 | 2.19E−03 | −4.63E−04 | 2.54E−04 | −1.69E−05 | −1.63E−05 |

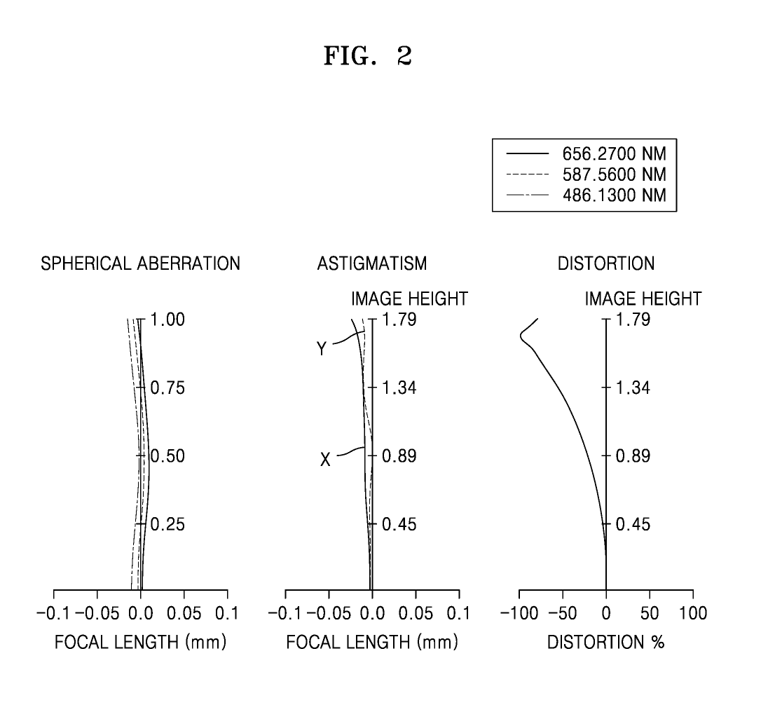

FIG. 2 shows a longitudinal spherical aberration, astigmatism, and a distortion of the wide angle lens according to the first numerical example. The astigmatism shows a tangential field curvature (Y) and a sagittal field curvature (X).

### SECOND NUMERICAL EXAMPLE

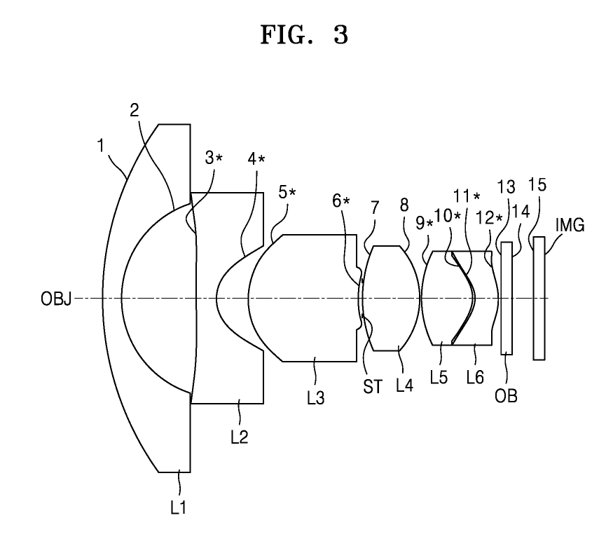

FIG. 3 shows a wide angle lens according to a second numerical example, and design data of the second numerical example is shown below.

TABLE 3

| | F-number | R | D | Nd | Vd |
|---|---|---|---|---|---|
| L1 | 1 | 10.90942 | 0.65 | 1.7725 | 49.6 |
| | 2 | 3.596838 | 2.710018 | | |
| L2 | *3 | −201.115 | 0.72975 | 1.5365 | 55.9 |
| | *4 | 1.188065 | 1.172219 | | |
| L3 | *5 | 2.798949 | 4 | 1.6322 | 23.3 |
| | *6 | 4.216362 | 0.137741 | | |
| | 7(St) | ∞ | 0.01 | | |
| L4 | 8 | 4.715289 | 2.085574 | 1.6204 | 60.3 |
| | 9 | −2.8 | 0.05 | | |
| L5 | *10 | 3.785257 | 1.860158 | 1.5365 | 55.9 |
| | *11 | −1.13757 | 0.085359 | | |
| L6 | *12 | −0.88849 | 0.855056 | 1.6322 | 23.3 |
| | *13 | −1.73713 | 0.1 | | |
| OB | 14 | ∞ | 0.4 | 1.523 | 39.1 |
| | 15 | ∞ | 0.775 | | |
| | 16 | ∞ | 0.4 | 1.517 | 64.2 |
| | IMG | ∞ | 0.125 | | |

TABLE 4

| S | K | A | B | C | D | E | F | G |
|---|---|---|---|---|---|---|---|---|
| *3 | 0.00E+00 | 2.30E−03 | −7.71E−04 | 7.74E−05 | −3.97E−06 | 9.08E−08 | 0.00E+00 | 0.00E+00 |
| *4 | −7.97E−01 | −1.65E−02 | 1.59E−02 | −2.67E−03 | −7.58E−04 | 1.42E−04 | 0.00E+00 | 0.00E+00 |
| *5 | 0.00E+00 | −3.06E−04 | 5.83E−03 | −1.60E−03 | 1.09E−04 | 0.00E+00 | 0.00E+00 | 0.00E+00 |
| *6 | 0.00E+00 | 4.16E−02 | −8.68E−02 | 2.36E−01 | −2.16E−01 | 0.00E+00 | 0.00E+00 | 0.00E+00 |
| *10 | 9.68E−01 | −4.35E−03 | 1.75E−03 | 7.37E−04 | −1.29E−03 | 8.80E−05 | 1.69E−04 | −3.00E−05 |
| *11 | −1.71E+00 | 2.15E−02 | 6.86E−03 | −9.74E−03 | 2.09E−03 | 2.71E−04 | −7.21E−05 | 3.53E−06 |
| *12 | −1.82E+00 | 5.72E−02 | −1.27E−02 | −2.23E−03 | 1.12E−03 | −6.08E−05 | 1.47E−04 | −4.49E−05 |
| *13 | −4.24E+00 | 4.56E−02 | −5.40E−03 | 1.95E−03 | −4.90E−04 | 2.70E−04 | −1.29E−05 | −1.58E−05 |

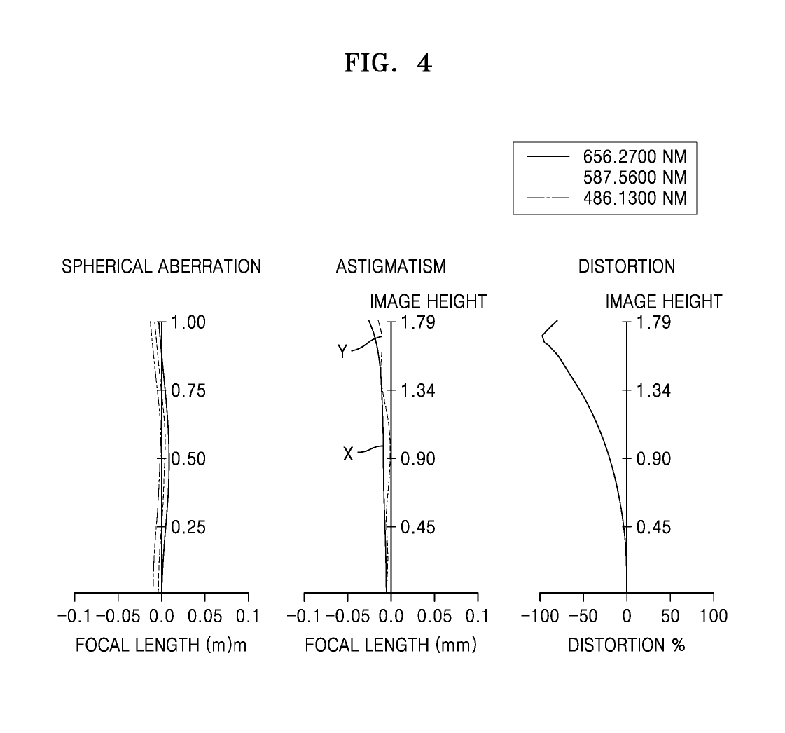

FIG. 4 shows a longitudinal spherical aberration, astigmatism, and a distortion of the wide angle lens according to the second numerical example. The astigmatism shows a tangential field curvature (Y) and a sagittal field curvature (X).

### THIRD NUMERICAL EXAMPLE

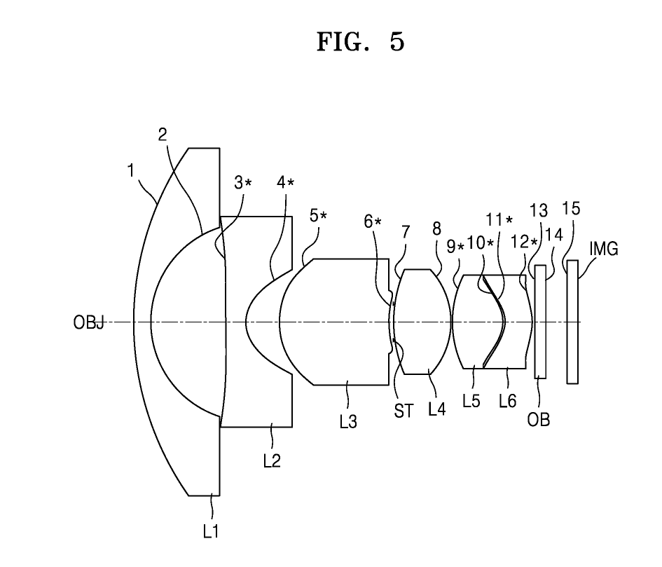

FIG. 5 shows a wide angle lens according to a third numerical example, and design data of the third numerical example is shown below.

TABLE 5

| | F-number | R | D | Nd | Vd |
|---|---|---|---|---|---|
| L1 | 1 | 10.8168 | 0.65 | 1.7725 | 49.6 |
| | 2 | 3.600712 | 2.729727 | | |
| L2 | *3 | −101.542 | 0.726408 | 1.5365 | 55.9 |
| | *4 | 1.203262 | 1.225102 | | |
| L3 | *5 | 2.79548 | 4 | 1.6322 | 23.3 |
| | *6 | 4.096702 | 0.151455 | | |
| | 7(St) | ∞ | 0.01 | | |
| L4 | 8 | 4.665705 | 2.090807 | 1.6204 | 60.3 |
| | 9 | −2.8 | 0.05 | | |
| L5 | *10 | 3.787292 | 1.842328 | 1.5365 | 55.9 |
| | *11 | −1.18462 | 0.081869 | | |
| L6 | *12 | −0.93819 | 0.988545 | 1.6322 | 23.3 |
| | *13 | −1.88442 | 0.1 | | |
| OB | 14 | ∞ | 0.4 | 1.523 | 39.1 |
| | 15 | ∞ | 0.775 | | |
| | 16 | ∞ | 0.4 | 1.517 | 64.2 |
| | IMG | ∞ | 0.125 | | |

TABLE 6

| S | K | A | B | C | D | E | F | G |
|---|---|---|---|---|---|---|---|---|
| *3 | 0.00E+00 | 2.35E−03 | −7.71E−04 | 7.76E−05 | −3.94E−06 | 8.88E−08 | 0.00E+00 | 0.00E+00 |
| *4 | −7.93E−01 | −1.70E−02 | 1.51E−02 | −2.48E−03 | −7.25E−04 | 1.40E−04 | 0.00E+00 | 0.00E+00 |
| *5 | 0.00E+00 | −1.68E−03 | 5.84E−03 | −1.72E−03 | 1.39E−04 | 0.00E+00 | 0.00E+00 | 0.00E+00 |
| *6 | 0.00E+00 | 3.77E−02 | −6.91E−02 | 1.76E−01 | −1.51E−01 | 0.00E+00 | 0.00E+00 | 0.00E+00 |
| *10 | 9.31E−01 | −4.75E−03 | 1.73E−03 | 7.78E−04 | −1.27E−03 | 9.64E−05 | 1.71E−04 | −3.14E−05 |
| *11 | −1.73E+00 | 2.19E−02 | 6.73E−03 | −9.80E−03 | 2.08E−03 | 2.85E−04 | −6.49E−05 | 3.81E−06 |
| *12 | −1.81E+00 | 5.58E−02 | −1.29E−02 | −2.16E−03 | 1.14E−03 | −6.72E−05 | 1.48E−04 | −4.34E−05 |
| *13 | −4.53E+00 | 4.18E−02 | −5.50E−03 | 1.99E−03 | −5.44E−04 | 2.59E−04 | −1.11E−05 | −1.34E−05 |

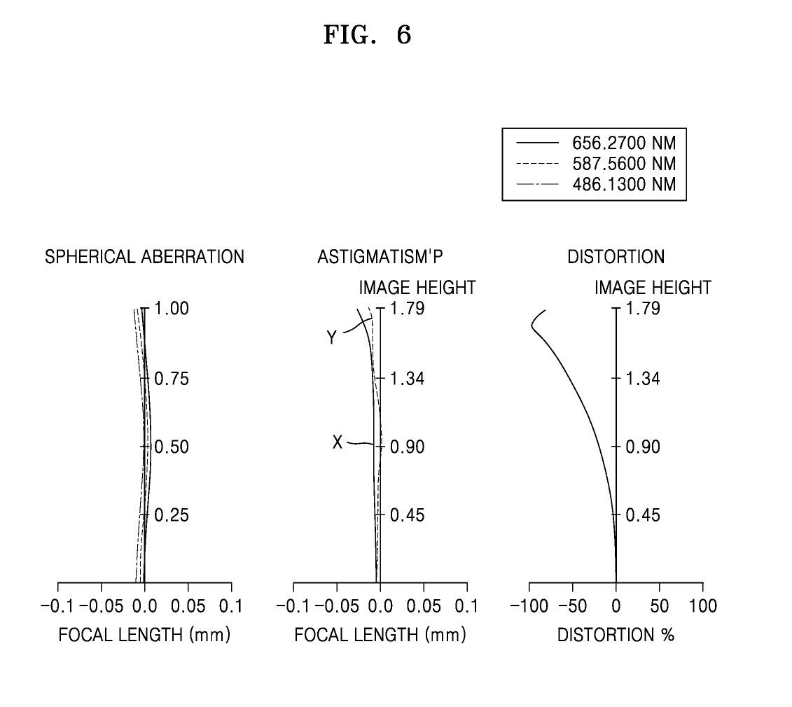

FIG. 6 shows a longitudinal spherical aberration, astigmatism, and a distortion of the wide angle lens according to the third numerical example. The astigmatism shows a tangential field curvature (Y) and a sagittal field curvature (X).

### FORTH NUMERICAL EXAMPLE

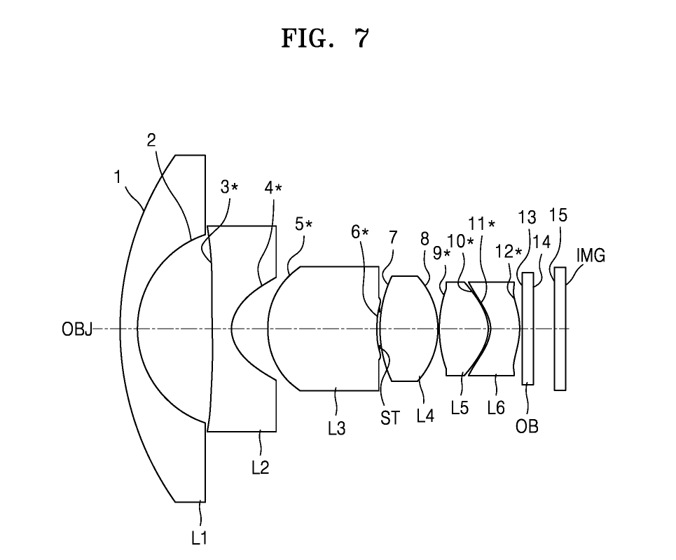

FIG. 7 shows a wide angle lens according to a fourth numerical example, and design data of the fourth numerical example is shown below.

TABLE 7

| | F-number | R | D | Nd | Vd |
|---|---|---|---|---|---|
| L1 | 1 | 10.82391 | 0.65 | 1.7725 | 49.6 |
| | 2 | 3.6004 | 2.713183 | | |
| L2 | *3 | −136.093 | 0.714296 | 1.5365 | 55.9 |
| | *4 | 1.20944 | 1.319789 | | |
| L3 | *5 | 2.812932 | 4 | 1.6322 | 23.3 |
| | *6 | 4.033411 | 0.095326 | | |
| | 7(St) | ∞ | 0.01 | | |
| L4 | 8 | 4.380393 | 2.123623 | 1.6204 | 60.3 |
| | 9 | −2.8 | 0.05 | | |
| L5 | *10 | 3.956358 | 1.791665 | 1.5365 | 55.9 |
| | *11 | −1.24437 | 0.076478 | | |
| L6 | *12 | −1.00766 | 1.073387 | 1.6322 | 23.3 |
| | *13 | −2.05228 | 0.1 | | |
| OB | 14 | ∞ | 0.4 | 1.523 | 39.1 |
| | 15 | ∞ | 0.775 | | |
| | 16 | ∞ | 0.4 | 1.517 | 64.2 |
| | IMG | ∞ | 0.125 | | |

TABLE 8

| S | K | A | B | C | D | E | F | G |
|---|---|---|---|---|---|---|---|---|
| *3 | 0.00E+00 | 2.36E−03 | −7.71E−04 | 7.72E−05 | −3.82E−06 | 8.24E−08 | 0.00E+00 | 0.00E+00 |
| *4 | −8.11E−01 | −1.05E−02 | 1.16E−02 | −1.99E−03 | −6.34E−04 | 1.29E−04 | 0.00E+00 | 0.00E+00 |
| *5 | 0.00E+00 | −1.41E−03 | 4.93E−03 | −1.61E−03 | 1.55E−04 | 0.00E+00 | 0.00E+00 | 0.00E+00 |
| *6 | 0.00E+00 | 3.35E−02 | −5.52E−02 | 1.42E−01 | −1.19E−01 | 0.00E+00 | 0.00E+00 | 0.00E+00 |
| *10 | 6.99E−01 | −4.78E−03 | 5.40E−04 | 9.16E−04 | −1.24E−03 | 4.06E−05 | 1.39E−04 | −2.70E−05 |
| *11 | −1.64E+00 | 1.97E−02 | 6.54E−03 | −9.78E−03 | 2.11E−03 | 2.74E−04 | −7.55E−05 | −7.56E−06 |
| *12 | −1.73E+00 | 5.71E−02 | −1.25E−02 | −2.16E−03 | 1.10E−03 | −5.76E−05 | 1.41E−04 | −4.48E−05 |
| *13 | −4.52E+00 | 4.14E−02 | −5.16E−03 | 2.12E−03 | −5.57E−04 | 2.05E−04 | −1.67E−05 | −5.15E−06 |

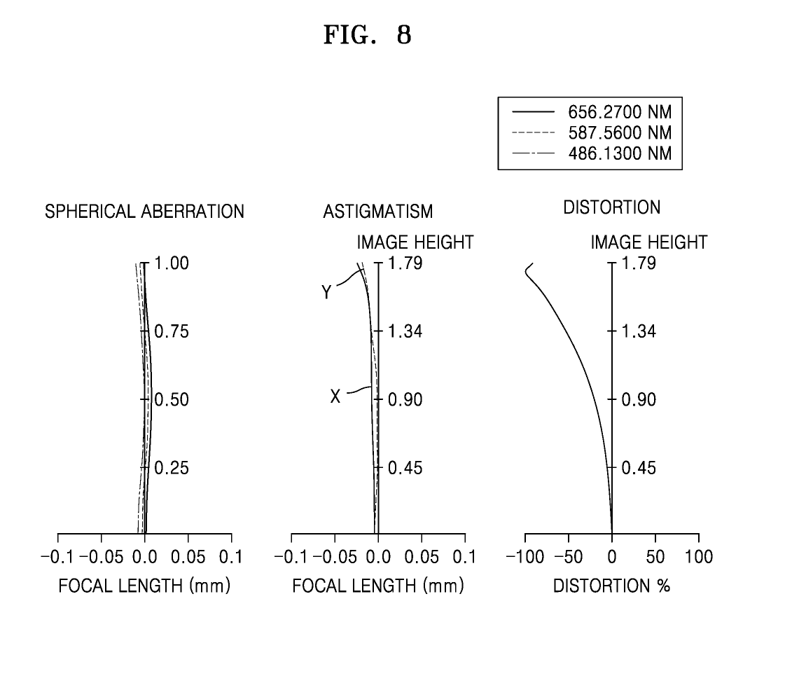

FIG. 8 shows a longitudinal spherical aberration, astigmatism, and a distortion of the wide angle lens according to the fourth numerical example.

The astigmatism shows a tangential field curvature (Y) and a sagittal field curvature (X).

### FIFTH NUMERICAL EXAMPLE

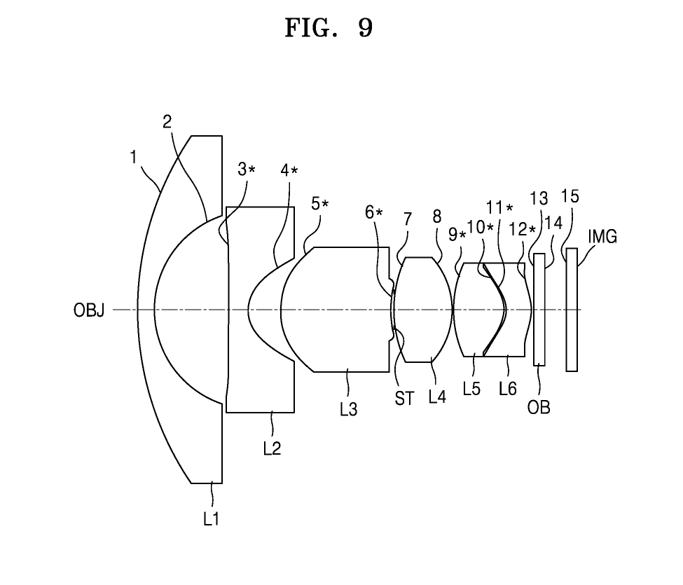

FIG. 9 shows a wide angle lens according to a fifth numerical example, and design data of the fifth numerical example is shown below.

TABLE 9

| | F-number | R | D | Nd | Vd |
|---|---|---|---|---|---|
| L1 | 1 | 11.00287 | 0.65 | 1.7725 | 49.6 |
| | 2 | 3.593149 | 2.68239 | | |
| L2 | *3 | 893.104 | 0.72207 | 1.5365 | 55.9 |
| | *4 | 1.200014 | 1.181129 | | |
| L3 | *5 | 2.826029 | 4 | 1.6322 | 23.3 |
| | *6 | 4.258338 | 0.109972 | | |
| | 7(St) | ∞ | 0.01 | | |
| L4 | 8 | 4.524481 | 2.106404 | 1.6204 | 60.3 |
| | 9 | −2.8 | 0.05 | | |
| L5 | *10 | 3.860483 | 1.832216 | 1.5365 | 55.9 |
| | *11 | −1.16707 | 0.086079 | | |
| L6 | *12 | −0.90525 | 0.905026 | 1.6322 | 23.3 |
| | *13 | −1.76844 | 0.1 | | |
| OB | 14 | ∞ | 0.4 | 1.523 | 39.1 |
| | 15 | ∞ | 0.775 | | |
| | 16 | ∞ | 0.4 | 1.517 | 64.2 |
| | IMG | ∞ | 0.125 | | |

TABLE 10

| S | K | A | B | C | D | E | F | G |
|---|---|---|---|---|---|---|---|---|
| *3 | 0.00E+00 | 2.24E−03 | −7.71E−04 | 7.72E−05 | −4.01E−06 | 9.37E−08 | 0.00E+00 | 0.00E+00 |
| *4 | −8.00E−01 | −1.07E−02 | 1.43E−02 | −2.59E−03 | −7.30E−04 | 1.42E−04 | 0.00E+00 | 0.00E+00 |
| *5 | 0.00E+00 | 7.90E−04 | 5.25E−03 | −1.54E−03 | 1.15E−04 | 0.00E+00 | 0.00E+00 | 0.00E+00 |
| *6 | 0.00E+00 | 3.92E−02 | −8.42E−02 | 2.31E−01 | −2.12E−01 | 0.00E+00 | 0.00E+00 | 0.00E+00 |
| *10 | 9.10E−01 | −4.55E−03 | 9.68E−04 | 7.85E−04 | −1.28E−03 | 8.39E−05 | 1.61E−04 | −2.86E−05 |
| *11 | −1.68E+00 | 2.06E−02 | 6.93E−03 | −9.59E−03 | 2.14E−03 | 2.63E−04 | −7.53E−05 | −1.39E−06 |
| *12 | −1.77E+00 | 5.92E−02 | −1.20E−02 | −2.17E−03 | 1.08E−03 | −5.10E−05 | 1.47E−04 | −4.76E−05 |
| *13 | −3.98E+00 | 4.55E−02 | −4.72E−03 | 2.14E−03 | −5.13E−04 | 2.12E−04 | −1.72E−05 | −9.51E−06 |

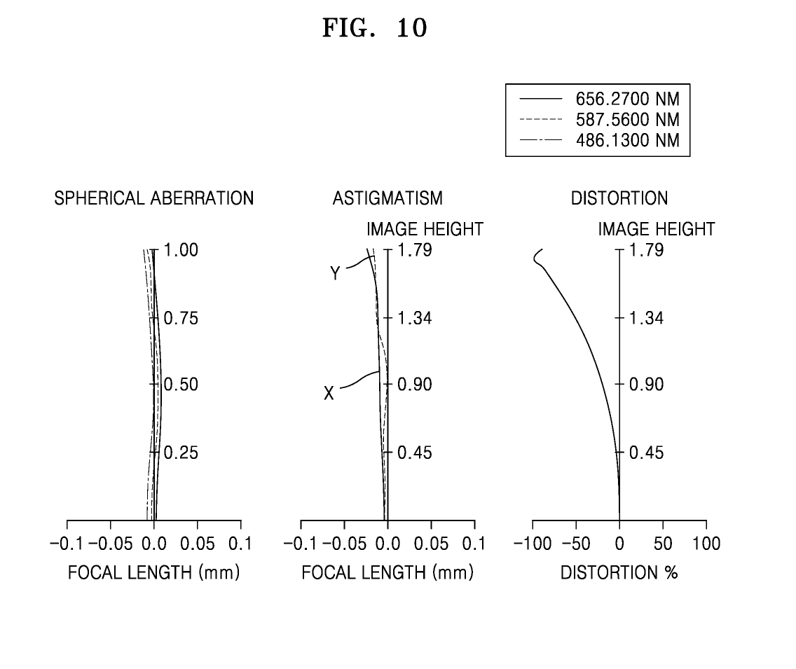

FIG. 10 shows a longitudinal spherical aberration, astigmatism, and a distortion of the wide angle lens according to the fifth numerical example. The astigmatism shows a tangential field curvature (Y) and a sagittal field curvature (X).

Next, the wide angle lenses according to the first to fifth numerical examples exhibit will be shown to satisfy Conditional Expressions 1 to 5. In Table 11, FOV denotes an angle of view of the wide angle lens, EFL denotes an effective focal length of the wide angle lens, f3 denotes a focal length of the third lens L3, TTL denotes a full length of the wide angle lens, |R7| denotes an absolute value of a radius of curvature of the incident surface 7 of the fourth lens L4, |R8| denotes an absolute value of a radius of curvature of the exit surface 8 of the fourth lens L4, Vd3 denotes an Abbe number with respect to a d-line of the third lens L3, and Vd6 denotes an Abbe number with respect to a d-line of the sixth lens L6.

TABLE 11

| | | | | | Conditional | | |
|---|---|---|---|---|---|---|---|
| | Conditional | Conditional | Conditional | Conditional | Expression 5 | | |
| | Expression 1 | Expression 2 | Expression 3 | Expression 4 | (FOV/2) * | | |
| | FOV > 180 | EFL/f3 > 0.25 | \|R7\|/\|R8\| > 1.5 | Vd3 + Vd6 < 50 | (π/180)/IH | > | EFL |
| Example 1 | 190.6 | 0.258 | 1.68 | 46.6 | 0.928 | > | 0.824 |
| Example 2 | 190.5 | 0.266 | 1.68 | 46.6 | 0.928 | > | 0.839 |
| Example 3 | 190.4 | 0.274 | 1.67 | 46.6 | 0.927 | > | 0.862 |
| Example 4 | 185.4 | 0.286 | 1.56 | 46.6 | 0.903 | > | 0.886 |
| Example 5 | 185.5 | 0.276 | 1.62 | 46.6 | 0.903 | > | 0.862 |

Various variables of the wide angle lens according to the first to fifth numerical examples are summarized below. In Table 12, IH denotes the image height of the wide angle lens, FOV denotes the angle of view of the wide angle lens, Fno denotes an aperture value of the wide angle lens, EFL denotes the effective focal length of the wide angle lens, TTL denotes the full length of the wide angle lens, f3 denotes the focal length of the third lens L3, |R7| denotes the absolute value of the radius of curvature of the incident surface 7 of the fourth lens L4, and |R8| denotes the absolute value of the radius of curvature of the exit surface 8 of the fourth lens L4.

TABLE 12

| | IH (mm) | FOV (°) | F no. | EFL (mm) | TTL (mm) | f3 (mm) | EFL/f3 | \|R7\|/\|R8\| |
|---|---|---|---|---|---|---|---|---|
| Example 1 | 1.792 | 190.6 | 2.2 | 0.824 | 15.934 | 3.195 | 0.258 | 1.68 |
| Example 2 | 1.792 | 190.6 | 2.2 | 0.839 | 16.146 | 3.157 | 0.266 | 1.68 |
| Example 3 | 1.792 | 190.4 | 2.2 | 0.862 | 16.346 | 3.148 | 0.274 | 1.67 |
| Example 4 | 1.792 | 185.4 | 2.2 | 0.886 | 16.418 | 3.094 | 0.286 | 1.56 |
| Example 5 | 1.792 | 185.5 | 2.2 | 0.862 | 16.135 | 3.133 | 0.276 | 1.62 |

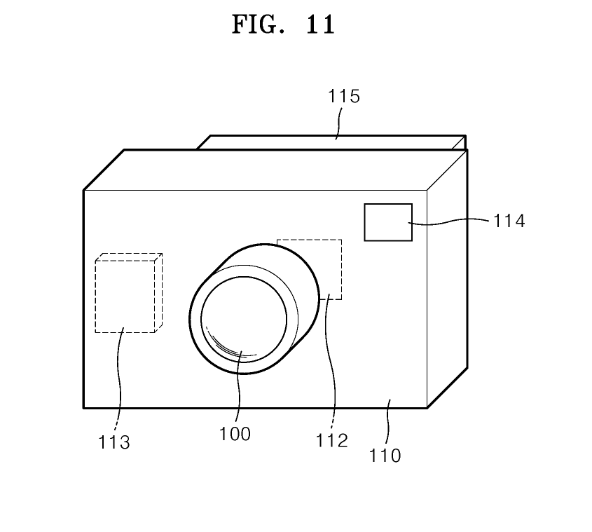

FIG. 11 illustrates an example of an imaging device 100 having a wide angle lens according to an exemplary embodiment. The wide angle lens may include the wide angle lenses described in the previous examples. The imaging device 100 includes an imaging element 112 configured to receive light which is imaged by the wide angle lens. The imaging device 100 may include a recorder 113 on which information corresponding to a subject image photoelectrically-converted in the imaging element 112 is recorded, and a view finder 114 configured to observe the subject image. Further, the imaging device 100 may further include a display 115 on which the subject image is displayed. Here, the example in which the view finder 114 and the display 115 are separately provided is shown, but only the display 115 may be provided without view finder 114.

The imaging device 100 shown in FIG. 11 is merely a general example, and the wide angle lenses may be applied to a variety of optical devices. For example, the wide angle lens according to the present embodiment may be applied to a lens system of a camera for a vehicle. The wide angle lens may also be applied to a virtual reality device, an augmented reality device, and the like. For example, in the virtual reality device, wide angle lenses according to the above-described embodiment may be provided to face opposite directions. For example, the wide angle lens according to the embodiments of the disclosure may be applied to various devices such as a black box, an around view monitoring (AVM) system, or a rear camera for a vehicle. Further, the wide angle lens may be applied to various action cams such as camcorders for drones and leisure sports. In addition, the wide angle lens may be applied to various surveillance cameras.

The wide angle lens according to the present disclosure may realize an optical system having a wide angle of view angle and good optical performance.

The wide angle lens according to the present disclosure may implement a lens optical system that may be implemented at a relatively low cost while having high reliability. Specifically, the wide angle lens according to the present disclosure may have a wider angle of view in a vertical direction than a conventional wide angle lens having equidistance and stereographic mapping characteristics. Accordingly, the wide angle lens and the imaging device according to the present disclosure may be easily used for applications such as a camera for a vehicle and a surveillance camera.

Further, the wide angle lens and the imaging device according to the present disclosure may easily (suitably) correct various aberrations, and thus may be advantageous for high performance, miniaturization, and weight reduction of the lens. Specifically, the wide angle lens and the imaging device according to the present disclosure simultaneously employ a glass lens and a plastic lens to realize a high performance optical system at a low cost while ensuring durability to a temperature change.

Further, although many matters are specifically described in the above description, such matters are not to be construed as limiting the scope of the invention, but rather should be interpreted as examples of preferred embodiments. For example, those skilled in the art should appreciate that, when at least one of Conditional Expressions 1 to 5 are satisfied, it can be seen that the above-described effects may be obtained even though shapes of lenses are somewhat modified from the wide angle lens according to the embodiment of the present disclosure. Further, even when at least some of Conditional Expressions 1 to 5 are not satisfied, it can be seen that the above-described effects may be obtained when the refractive power arrangement of the lenses, the shape condition, and other conditions are satisfied. It should be understood that various other modifications are possible. Therefore, the scope of the present disclosure is not to be determined by the described embodiments, and should be determined by the technical idea described in the appended claims.

It should be understood that embodiments described herein are to be considered in a descriptive sense only and not for purposes of limitation. Descriptions of features or aspects within each embodiment should typically be considered as available for other similar features or aspects in other embodiments.

While one or more embodiments have been described with reference to the figures, it should be understood by those of ordinary skill in the art that various changes in form and details may be made therein without departing from the spirit and scope of the disclosure as defined by the following claims.

What is claimed is:

1. A wide angle lens comprising:
a first lens having a negative refractive power and an incident surface that is convex toward an object side;
a second lens having a negative refractive power;
a third lens having a positive refractive power and an exit surface that is concave toward an image plane side;
a fourth lens having a positive refractive power;
a fifth lens having a positive refractive power; and
a sixth lens having a negative refractive power and an exit surface that is convex toward the image plane side,
wherein the first to sixth lenses are sequentially disposed from the object side to the image plane side, and
the wide angle lens satisfies Conditional Expression 1 as follows:
(FOV/2)*(π/180)/IH>EFL [Conditional Expression 1]
wherein FOV (having a unit of °) denotes an angle of view of the wide angle lens, IH denotes an image height of the wide angle lens, and EFL denotes an effective focal length of the wide angle lens.

2. The wide angle lens of claim 1 satisfies Conditional Expression 2 as follows:
FOV>180° [Conditional Expression 2]
wherein, FOV (having the unit of °) denotes the angle of view of the wide angle lens.

3. The wide angle lens of claim 1 satisfies Conditional Expression 3 as follows:
EFL/f3>0.25 [Conditional Expression 3]
wherein EFL denotes the effective focal length of the wide angle lens, and f3 denotes a focal length of the third lens.

4. The wide angle lens of claim 1 satisfies Conditional Expression 4 as follows:

|R7|/|R8|>1.5 [Conditional Expression 4]
wherein |R7| denotes an absolute value of a radius of curvature of an incident surface of the fourth lens, and |R8| denotes an absolute value of a radius of curvature of an exit surface of the fourth lens.

5. The wide angle lens of claim 1 satisfies Conditional Expression 5 as follows:
Vd3+Vd6<50 [Conditional Expression 5]
wherein Vd3 denotes an Abbe number of a d-line of the third lens, and Vd6 denotes an Abbe number of a d-line of the sixth lens.

6. The wide angle lens of claim 1, wherein the first lens and the fourth lens are each made of a glass material.

7. The wide angle lens of claim 1, wherein the second lens and the fifth lens are each made of a plastic material.

8. The wide angle lens of claim 1, wherein the third lens and the sixth lens are made of the same material.

9. The wide angle lens of claim 8, wherein the third lens and the sixth lens are each made of a plastic material.

10. The wide angle lens of claim 1, further comprising an aperture provided at the third lens toward the object side.

11. The wide angle lens of claim 1, wherein at least one lens among the second lens, the third lens, the fifth lens, and the sixth lens is an aspherical lens.

12. The wide angle lens of claim 1, wherein the first lens is a meniscus lens that is concave toward the image plane side.

13. The wide angle lens of claim 1, further comprising an optical block provided at the sixth lens toward the object side.

14. A wide angle lens comprising:
a first lens having a negative refractive power;
a second lens having a negative refractive power;
a third lens having a positive refractive power;
a fourth lens having a positive refractive power and an exit surface that is convex toward an image plane side;
a fifth lens having a positive refractive power; and
a sixth lens having a negative refractive power,
wherein the first to sixth lenses are sequentially disposed from an object side to the image plane side, and
the wide angle lens satisfies Conditional Expressions 1 and 2 as follows:
(FOV/2)*(π/180)/IH>EFL, and [Conditional Expression 1]

|R7|/|R8|>1.5 [Conditional Expression 2]
wherein FOV (having a unit of °) denotes an angle of view of the wide angle lens, IH denotes an image height of the wide angle lens, EFL denotes an effective focal length of the wide angle lens, |R7| denotes an absolute value of a radius of curvature of an incident surface of the fourth lens, and |R8| denotes an absolute value of a radius of curvature of the exit surface of the fourth lens.

15. The wide angle lens of claim 14 satisfies Conditional Expression 3 as follows:
FOV>180° [Conditional Expression 3]
wherein, FOV (having the unit of °) denotes the angle of view of the wide angle lens.

16. The wide angle lens of claim 14 satisfies Conditional Expression 4 as follows:
EFL/f3>0.25 [Conditional Expression 4]
wherein EFL denotes the effective focal length of the wide angle lens, and f3 denotes a focal length of the third lens.

17. The wide angle lens of claim 14 satisfies Conditional Expression 5 as follows:
Vd3+Vd6<50 [Conditional Expression 5]
wherein Vd3 denotes an Abbe number of a d-line of the third lens, and Vd6 denotes an Abbe number of a d-line of the sixth lens.

18. The wide angle lens of claim 14, wherein the first lens and the fourth lens are each made of a glass material.

19. The wide angle lens of claim 14, wherein the second lens, the third lens, the fifth lens, and the sixth lens are each made of a plastic material.

20. An imaging device comprising:
the wide angle lens according to claim 1; and
a solid-state imaging element configured to take an image formed by the wide angle lens.
